(19) United States
(12) Patent Application Publication
(10) Pub. No.: US 2007/0281180 A1
(43) Pub. Date: Dec. 6, 2007

(54) Suspended ornament and manufacturing method for the same

(76) Inventor: Yoshihiro Inoue, Osaka (JP)

Correspondence Address: KRATZ, QUINTOS & HANSON, LLP, 1420 K Street, N.W., Suite 400, WASHINGTON, DC, 20005, US

(21) Appl. No.: 11/442,391

(22) Filed: May 30, 2006

(51) Int. Cl. B31D 3/02; A47G 35/00

(52) U.S. Cl. 428/542.6; 428/12

(57) ABSTRACT

A suspended ornament having an ornament main body composed of an obverse natural-wood sheet body, a base fabric for adhesion, and a reverse natural-wood sheet body layered in this order and adhered to be united. The ornament main body is divided into plural fine long strips. Each of the fine long strips has plural fiber-cutting lines. All of the fine long strips are connected by knitting connection linear bodies as to be disposed in order before the division. Width dimension of the fine long strip is set to be 3 to 25 mm. Each of the fine long strips has plural fiber-cutting lines parallel to each other. Interval dimension between neighboring fiber-cutting lines is set to be 0.5 to 1.5 mm.

### BACKGROUND OF THE INVENTION

1. Field of the Invention

This invention relates to a suspended ornament and manufacturing method for the same.

2. Description of the Related Art

Conventionally, a suspended ornament is, for example, composed of cloth and paper (refer to the Japanese Patent Provisional Publication No. 2005-119251, for example).

However, a beautiful flat suspended ornament can not be made with a natural-wood sheet body cut out of natural wood because the natural-wood sheet body generally has deformations.

It is therefore an object of the present invention to provide a fine flat suspended ornament without deformations, made with natural-wood sheet bodies cut out of natural wood, and a manufacturing method for the same.

### BRIEF DESCRIPTION OF THE DRAWINGS

The present invention will be described with reference to the accompanying drawings in which:

FIG. 1 is a front view showing an embodiment of the present invention;

FIG. 2 is an enlarged cross-sectional view of a principal portion;

FIG. 3 is a front view showing a fine long strip;

FIG. 4 is an enlarged partial cross-sectional view of an ornament main body for explanation of manufacturing method;

FIG. 5 is a front view of the ornament main body;

FIG. 6 is an enlarged partial cross-sectional view of the ornament main body;

FIG. 7 is a front view of the ornament main body;

FIG. 8 is an enlarged partial cross-sectional view of the ornament main body; and

FIG. 9 is a front view of the ornament main body for explanation of another manufacturing method.

### PREFERRED EMBODIMENTS OF THE INVENTION

Preferred embodiments of the present invention will now be described with reference to the accompanying drawings.

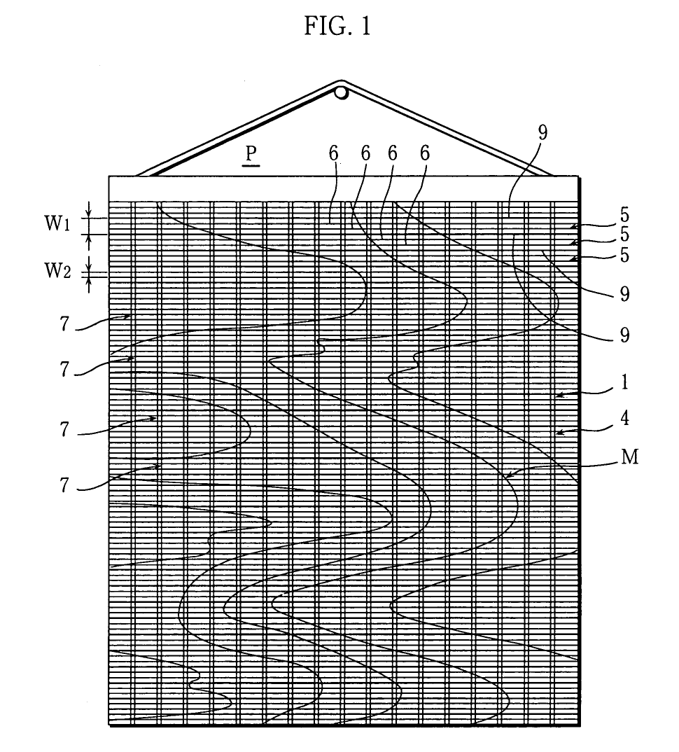

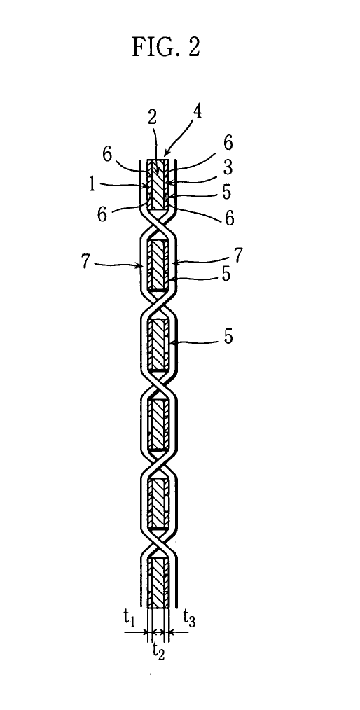

FIGS. 1 and 2 show an embodiment of the present invention. This suspended ornament is suspended from a wall P, a ceiling, etc. to be used as a partition, a curtain, a tapestry, etc. Concretely, the suspended ornament has an ornament main body 4 composed of an obverse natural-wood sheet body 1, a base fabric 2 for adhesion, and a reverse natural-wood sheet body 3 layered in this order and adhered to be united. The base fabric 2 is composed of woven or non-woven fabric. The base fabric 2 is impregnated or coated with adhesive.

A thickness dimension t₁ of the obverse natural-wood sheet body 1 is set to be 0.1 mm≦t₁≦0.3 mm. When the thickness dimension t₁ is within this range, the sheet body is easily made and given with characteristic flexibility. In case that the thickness dimension t₁ is t₁<0.1 mm, much labor is required to make the obverse natural-wood sheet body 1 out of natural wood. In case that the thickness dimension t₁ is 0.3 mm<t₁, the thickness dimension of the ornament main body 4 may be too large to obtain the characteristic flexibility.

A thickness dimension t₂ of the base fabric 2 is set to be 0.3 mm≦t₂≦0.5 mm. When the thickness dimension t₂ is within this range, the base fabric 2 is prevented from being cut and given with characteristic flexibility. In case that the thickness dimension t₂ of the base fabric 2 is t₂<0.3 mm, the base fabric may be cut when a fiber-cutting line 6 is formed. In case that the thickness dimension t₂ is 0.5 mm<t₂, the thickness dimension of the ornament main body 4 may be too large to obtain the characteristic flexibility.

A thickness dimension t₃ of the reverse natural-wood sheet body 3 is set to be 0.1 mm≦t₃≦0.3 mm. When the thickness dimension t₃ is within this range, the sheet body is easily made and given characteristic flexibility. In case that the thickness dimension t₃ is t₃<0.1 mm, much labor is required to make the reverse natural-wood sheet body 3 out of natural wood. In case that the thickness dimension t₃ is 0.3 mm<t₃, the thickness dimension of the ornament main body 4 may be too large to obtain the characteristic flexibility.

The ornament main body 4 is divided into plural fine long strips 5. Each of the fine long strips 5 has plural fiber-cutting lines 6 parallel to each other. All of the fine long strips 5 are connected by weaving with connection linear bodies 7 to be disposed in order before the division of the ornament main body 4. That is to say, when observed as a whole, a continuing pattern M of natural wood appears on the ornament.

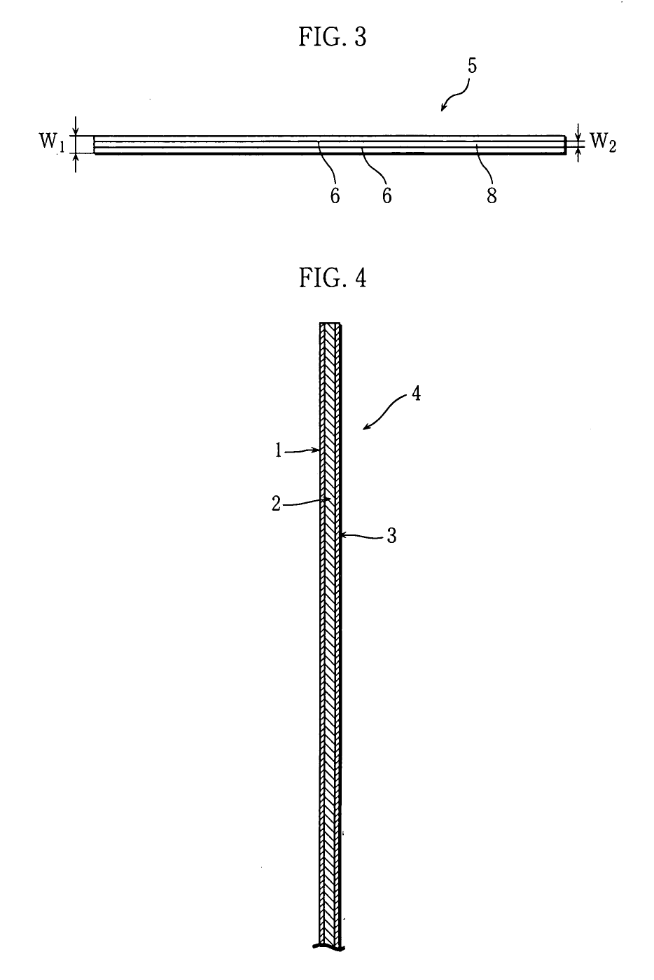

As shown in FIG. 3, a width dimension W₁ of the fine long strip 5 is set to be 3 mm≦W₁≦25 mm. When the width dimension W₁ of the fine long strip 5 is W₁<3 mm, much labor is required for production. When the width dimension W₁ is 25 mm<W₁, the tasteful interest of the suspended ornament is not sufficiently expressed.

An interval dimension W₂ between the neighboring fiber-cutting lines 6 is set to be 0.5 mm≦W₂≦1.5 mm. When the interval dimension W₂ is W₂<0.5 mm, a surface 8 of the fine long strip 5 has low quality appeal. When the interval dimension W₂ is 1.5 mm<W₂, fiber-cutting effect can not be sufficiently obtained, namely, the surface of the whole ornament can not be made fine.

Next, an embodiment of the manufacturing method of the suspended ornament of the present invention is described with FIGS. 4 through 8.

As shown in FIG. 4, the obverse natural-wood sheet body 1, the base fabric 2 for adhesion, and the reverse natural-wood sheet body 3 are serially layered in this order and adhered to be united for forming the ornament main body 4.

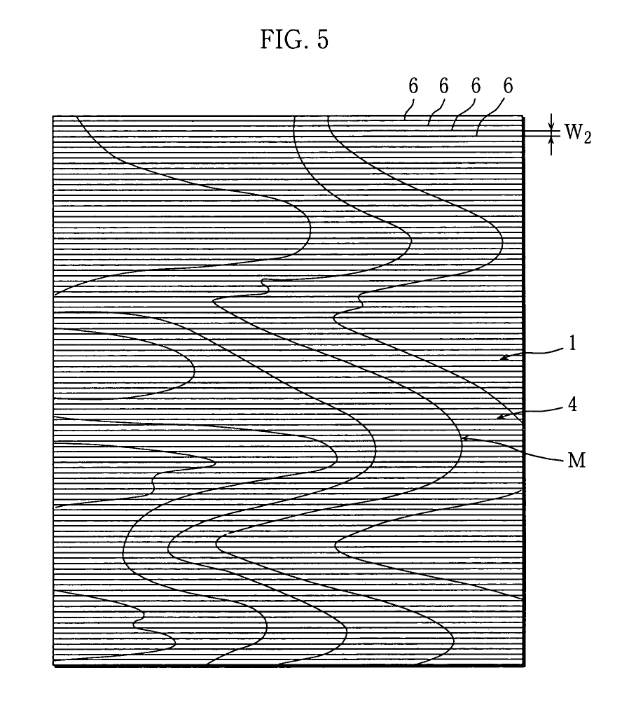

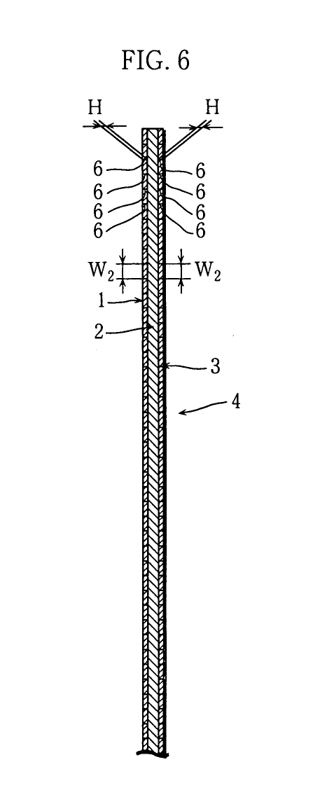

And, as shown in FIGS. 5 and 6, plural fiber-cutting lines 6, parallel to each other, are formed on the ornament main body 4 with the interval dimension W₂ of 0.5 mm≦W₂1.5 mm. A depth dimension H of the fiber-cutting line 6 is preferably set as to completely cut the obverse natural-wood sheet body 1 or the reverse natural-wood sheet body 3. When the depth dimension H is too small, the fiber is not sufficiently cut. And, when the depth dimension H is too large, the ornament main body 4 may be penetrated by the fiber-cutting line 6. And, the beautiful pattern of natural wood may not be sufficiently preserved.

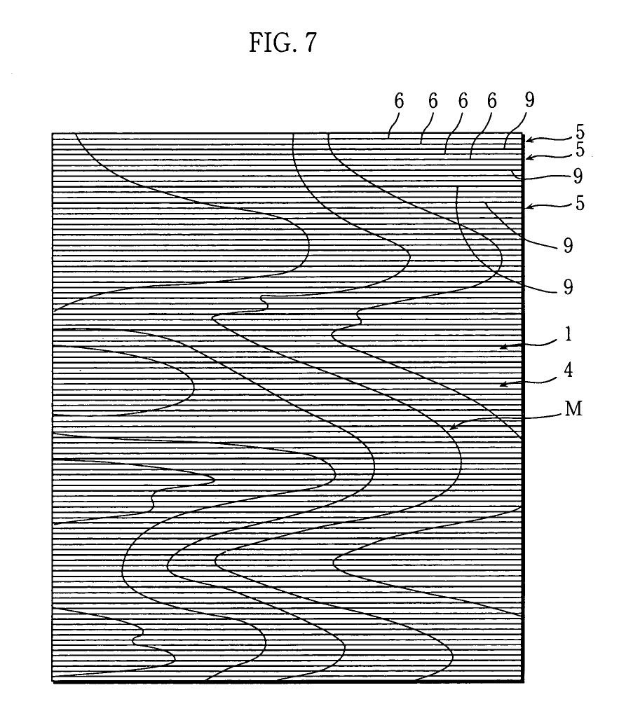

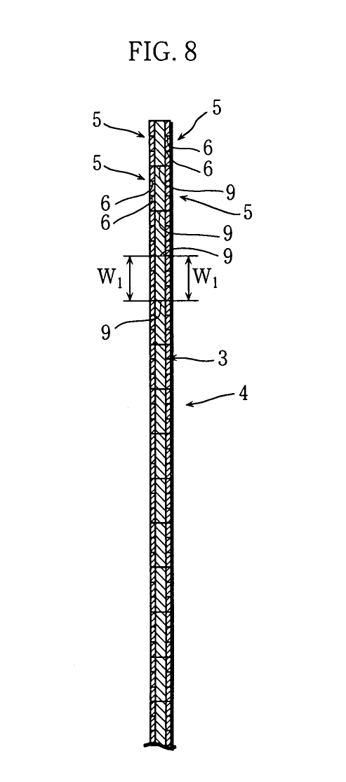

Then, as shown in FIGS. 7 and 8, the ornament main body 4 is divided into the plural fine long strips 5 each of which has the width dimension W₁ of 3 mm≦W₁≦25 mm. Marks 9 show divisional cutting lines.

Finally, all of the fine long strips 5 are connected by weaving with the connection linear bodies 7 to be disposed in order before the division of the ornament main body 4 (refer to FIGS. 1 and 2).

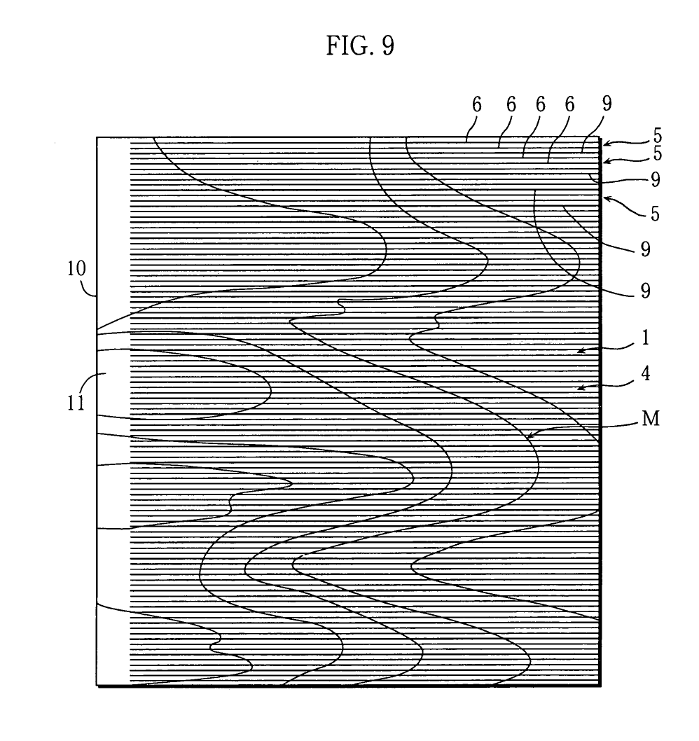

FIG. 9 shows another manufacturing method in which the whole configuration of the ornament is a rectangular sheet, and a non-cut continuing portion 11 is left along a side 10 in the process of dividing the ornament main body 4 into the plural fine long strips 5. Other processes are similar to that of the method above.

The present invention, modifiable in design, may have plural ornament main bodies 4. And, any type of weaving can be applied to the weaving of the fine long strips 5 and the connection linear bodies 7.

As described above, a fine flat suspended ornament can be made of the natural-wood sheet bodies (the obverse natural-wood sheet body 1 and the reverse natural-wood sheet body 3) without deformation because the ornament has the ornament main body 4 composed of the obverse natural-wood sheet body 1, the base fabric 2 for adhesion, and the reverse natural-wood sheet body 3 layered in this order and adhered to be united, the ornament main body 4 is divided into plural fine long strips 5, each of the fine long strips 5 has plural fiber-cutting lines 6, and all of the fine long strips 5 are connected by weaving with the connection linear bodies 7 as to be disposed in order before the division of the ornament main body 4. Especially, a suspended ornament having a large area as a whole can be made. And, the continuing pattern M of natural wood appears. And, the ornament main body 4 as a sheet has characteristic flexibility.

The ornament can be easily made and tasteful interest of the suspended ornament is sufficiently expressed because the width dimension W₁ of the fine long strip 5 is set to be 3 mm≦W₁≦25 mm, each of the fine long strips 5 has mutually-parallel plural fiber-cutting lines 6, and the interval dimension W₂ between the neighboring fiber-cutting lines 6 is set to be 0.5 mm≦W₂≦1.5 mm. And, the surface 8 of the fine long strip 5 has good quality appeal and the effect of fiber cutting is sufficiently obtained. And, the ornament main body 4 as a sheet has characteristic flexibility.

A fine flat suspended ornament can be made of the natural-wood sheet bodies (the obverse natural-wood sheet body 1 and the reverse natural-wood sheet body 3) without deformation because the ornament main body 4 is formed with the obverse natural-wood sheet body 1, the base fabric 2 for adhesion, and the reverse natural-wood sheet body 3 layered in this order and adhered to be united, plural fiber-cutting lines 6 are formed on the ornament main body 4, the ornament main body 4 is divided into plural fine long strips 5, and all of the fine long strips 5 are connected by weaving with the connection linear bodies 7 as to be disposed in order before the dividing of the ornament main body 4. Especially, a suspended ornament having a large area as a whole can be made. And, the continuing pattern M of natural wood appears. And, the ornament main body 4 as a sheet has characteristic flexibility.

The ornament can be easily made and tasteful interest of the suspended ornament is sufficiently expressed because the ornament main body 4 is formed with the obverse natural-wood sheet body 1, the base fabric 2 for adhesion, and the reverse natural-wood sheet body 3 layered in this order and adhered to be united, plural fiber-cutting lines 6 are formed on the ornament main body 4 with the interval dimension W₂ of 0.5 mm to 1.5 mm, the ornament main body 4 is divided into plural fine long strips 5 of which width dimension W₁ is 3 mm to 25 mm, and all of the fine long strips 5 are connected by weaving with the connection linear bodies 7 as to be disposed in order before the dividing of the ornament main body 4. And, the surface 8 of the fine long strip 5 has good quality appeal and the effect of fiber cutting is sufficiently obtained. And, the ornament main body 4 is given characteristic flexibility.

The fine long strips 5 can be easily connected further by weaving with the connection linear bodies 7 because whole configuration of the ornament main body 4 is a rectangular sheet, and the non-cut continuing portion 11 is left along the side 10 of the ornament main body 4 in the process of dividing the ornament main body 4 into plural fine long strips 5.

While preferred embodiments of the present invention have been described in this specification, it is to be understood that the invention is illustrative and not restrictive, because various changes are possible within the spirit and indispensable features.

1. A suspended ornament comprising a construction in which an ornament main body composed of an obverse natural-wood sheet body, a base fabric for adhesion, and a reverse natural-wood sheet body are layered in this order and adhered to be united, the ornament main body is divided into plural fine long strips, each of the fine long strips has plural fiber-cutting lines, and all of the fine long strips are connected by weaving with connection linear bodies as to be disposed in order before the division of the ornament main body.

2. The suspended ornament as set forth in claim 1, wherein a width dimension of the fine long strip is set to be 3 mm to 25 mm, each of the fine long strips has mutually-parallel plural fiber-cutting lines, and an interval dimension between the neighboring fiber-cutting lines is set to be 0.5 mm to 1.5 mm.

3. A manufacturing method for suspended ornament comprising the steps of:
forming an ornament main body with an obverse natural-wood sheet body, a base fabric for adhesion, and a reverse natural-wood sheet body layered in this order and adhered to be united;
forming plural fiber-cutting lines on the ornament main body;
dividing the ornament main body into plural fine long strips; and
connecting all of the fine long strips by weaving with connection linear bodies as to be disposed in order before the dividing of the ornament main body.

4. A manufacturing method for suspended ornament comprising the steps of:
forming an ornament main body with an obverse natural-wood sheet body, a base fabric for adhesion, and a reverse natural-wood sheet body layered in this order and adhered to be united;
forming mutually-parallel plural fiber-cutting lines with an interval dimension of 0.5 mm to 1.5 mm on the ornament main body;
dividing the ornament main body into plural fine long strips of which width dimension is 3 mm to 25 mm; and
connecting all of the fine long strips by weaving with connection linear bodies as to be disposed in order before the dividing of the ornament main body.

5. The manufacturing method for suspended ornament as set forth in claim 3, wherein whole configuration of the ornament main body is a rectangular sheet, and a non-cut continuing portion is left along a side of the ornament main body in the process of dividing the ornament main body into the plural fine long strips.

6. The manufacturing method for suspended ornament as set forth in claim 4, wherein whole configuration of the ornament main body is a rectangular sheet, and a non-cut continuing portion is left along a side of the ornament main body in the process of dividing the ornament main body into the plural fine long strips.
